(19) United States
(12) Patent Application Publication
(10) Pub. No.: US 2010/0083321 A1
(43) Pub. Date: Apr. 1, 2010

(54) VIDEO-ON-DEMAND METHOD AND SYSTEM

(76) Inventor: Thomas SCHREIBER, Pacific Palisades, CA (US)

Correspondence Address: FOLEY AND LARDNER LLP;SUITE 500, 3000 K STREET NW, WASHINGTON, DC, 20007, US

(21) Appl. No.: 12/239,162

(22) Filed: Sep. 26, 2008

(51) Int. Cl. H04N 7/173

(52) U.S. Cl. 725/87

(57) ABSTRACT

A video-on-demand method for a system that is not an audiovisual control entity, comprising: negotiating a different respective contract with each of one or more audiovisual control entities, wherein the respective contract with each of the one or more respective audiovisual control entities obtains a right with respect to each of a plurality of audiovisual works controlled by the respective audiovisual control entity, to offer a sale of a hard copy of the respective audiovisual work only when coupled with a substantially immediate viewing of the respective audiovisual work; receiving electronically information indicating a sale to a subscriber of the hard copy of the respective audiovisual work coupled with the substantially immediate viewing of the respective audiovisual work; generating an electronic record of the sale; and sending an instruction to a fulfillment entity to send a hard copy of the respective audiovisual work to the subscriber.

### BACKGROUND OF THE INVENTION

Historically, movie studios have staggered distribution points—called “windows” in the industry—to maximize revenue. A movie is generally released first to theaters, then several months later on DVD. Weeks or months after that, the movie is released through video-on-demand and on other platforms, with pay-per-view and regular television release coming last. But significant inefficiencies arise in selling copies of new movies to customers and also selling video on demand.

### SUMMARY OF THE INVENTION

In one embodiment, a video-on-demand method for a system that is not an audiovisual control entity is disclosed, comprising: negotiating a different respective contract with each of one or more audiovisual control entities, wherein the respective contract with each of the one or more respective audiovisual control entities obtains a right with respect to each of a plurality of audiovisual works controlled by the respective audiovisual control entity, to offer a sale of a hard copy of the respective audiovisual work only when coupled with a substantially immediate viewing of the respective audiovisual work; receiving electronically information indicating a sale to a subscriber of the hard copy of the respective audiovisual work coupled with the substantially immediate viewing of the respective audiovisual work; generating an electronic record of the sale; and sending an instruction to a fulfillment entity to send a hard copy of the respective audiovisual work to the subscriber. In one embodiment, the instruction to the fulfillment entity may be sent electronically.

In a further embodiment, the method is operating a system that is not an audiovisual delivery entity, and further comprises: negotiating a different respective contract with each of one or more respective audiovisual delivery entities, wherein the respective contract with respect to each of the one or more respective audiovisual delivery entities provides a right to offer to subscribers of the respective audiovisual delivery entity a sale of the hard copy of the audiovisual work only if sold in combination with a substantially immediate viewing of the audiovisual work.

In a yet further embodiment, the method comprises: determining electronically if a hard copy of the audiovisual work is available from one or more fulfillment entities within a period of time; and preventing electronically the sale to a subscriber of the hard copy of the audiovisual work coupled with the substantially immediate viewing of the audiovisual work if the hard copy of the audiovisual work is not available for fulfillment within the period of time.

In a yet further embodiment, the method comprising: determining electronically from each of a plurality of fulfillment entities one from the group of cost of the hard copy of the audiovisual work and in-stock information for the audiovisual work; and selecting one of the fulfillment entities to send the instruction to provide the hard copy of the audiovisual work.

In a yet further embodiment, the method is performed relative to a plurality of the audiovisual works that were released for a first theatrical run some period of time before the sale.

In a yet further embodiment, the substantially immediate viewing is limited to a single viewing during an immediate viewing availability period.

In a yet further embodiment, the method is performed only after a plurality of the audiovisual works were released for individual hard copy sales.

In a yet further embodiment, the method comprises: accumulating sales of a plurality of audiovisual works over a period of time; and wherein the sending step comprises generating and sending information on the accumulated sales of the plurality of audiovisual works to the fulfillment entity at one time.

In a yet further embodiment, the method comprises: receiving electronically a message indicating that the subscriber has requested to buy a hard copy of the audiovisual work coupled with the sale of a substantially immediate viewing of the audiovisual work; and sending electronically or having sent electronically a message either approving or denying the sale of the hard copy and the immediate viewing of the audiovisual work based on a criterion. In one embodiment, the criterion is a credit approval.

In a yet further embodiment, the method comprises: sending the audiovisual work to a vendor to have copyprotect software added to an electronic file containing the audiovisual work.

In a yet further embodiment, the method comprises: accessing electronically a database of audiovisual delivery subscribers and determining other audiovisual works that may be of interest to the subscriber based on a criterion. In one embodiment, the criterion is one or more audiovisual works viewed or purchased in the past by the subscriber.

In a yet further embodiment, the method comprises: uploading electronically to the audiovisual delivery entity an advertisement for playing to one or more subscribers.

In a yet further embodiment, the method comprises: accumulating over a period of time information on sales of hard copies of the audiovisual works coupled with an immediate viewing of the audiovisual works; calculating electronically a monetary amount owed to the audiovisual control entity based on the information about the sales; and communicating monetary amount data relating to the monetary amount owed to the audiovisual control entity.

In a yet further embodiment, the method comprises: accumulating over a period of time information on sales of hard copies of the audiovisual works coupled with an immediate viewing of the audiovisual works; calculating electronically a monetary amount owed by the audiovisual delivery entity based on the information about the sales; and communicating monetary amount data relating to the monetary amount owed to the audiovisual delivery entity.

In a yet further embodiment, the method comprises: creating an electronic log of sales of hard copies of the audiovisual works coupled with an immediate viewing of audiovisual works; and generating an electronic report based on the log.

In a yet further embodiment, the method comprises: maintaining or having maintained or an electronic database containing subscriber profiles, with each subscriber profile comprising a plurality of parameters.

In a yet further embodiment, the method comprises: maintaining or having maintained a Website with one or more Web pages displaying a plurality of audiovisual works available for a sale of a hard copy of the audiovisual work coupled with an immediate viewing of the audiovisual work, with the Web page configured to allow access and updating of an electronic profile of the subscriber after appropriate authentication. In a yet further embodiment, the Web page is configured to allow access electronically to a purchase history for the subscriber after appropriate authentication. In a yet further embodiment, the method comprises: the web page displaying a purchase indicator that allows a subscriber to buy a sale of a hard copy of the audiovisual work coupled with the immediate viewing of the audiovisual work.

In a yet further embodiment, the method comprises: receiving electronically one or more shipping addresses from a subscriber to facilitate delivery of a gift of the hard copy of the audiovisual work. This information is then provided to the fulfillment entity.

In a yet further embodiment, the method comprises: providing electronically tracking data for display relating to delivery of the hard copy of the audiovisual work.

In a yet further embodiment, the method comprises: providing electronically an out-of-stock message to the subscriber.

In a yet further embodiment, the method comprises: receiving electronically a list comprising a plurality of audiovisual works now available for sale of a hard copy of the audiovisual work coupled with substantially immediate viewing of the audiovisual work substantially immediate viewing coupled with sales of hard copies of the audiovisual works; and sending less than the entire list of the audiovisual works now available to the audiovisual delivery entity.

In a yet further embodiment, there are a plurality of audiovisual control entities, with a different contract negotiated with each of these plurality of audiovisual work control entities; and there are a plurality of audiovisual delivery entities, with a different contract negotiated with each of these audiovisual delivery entities.

In a yet further embodiment, the method comprises: maintaining or having maintained a Website with one or more Web pages displaying a plurality of audiovisual works available for a sale of a hard copy of the audiovisual work coupled with an immediate viewing of the audiovisual work, with the Web page configured to provide information to permit activating an electronic file disposed in a hard copy of the audiovisual work.

In a yet further embodiment, the method comprises: maintaining or having maintained a Website with one or more Web pages displaying a plurality of audiovisual works available for a sale of a hard copy of the audiovisual work coupled with an immediate viewing of the audiovisual work, with the Web page configured for the sale and download of an electronic copy of the audiovisual work.

In a yet further embodiment, the method comprises: maintaining or having maintained a Website, with one or more Web pages displaying a plurality of audiovisual works available for a sale of a hard copy of the audiovisual work coupled with an immediate viewing of the audiovisual work; and a purchase indicator that allows a subscriber to buy the hard copy of the audiovisual work coupled with the immediate viewing of the audiovisual work.

In a yet further embodiment, the method comprises: agreeing in the contract to provide to the audiovisual control entity a right to purchase an ownership interest of a company operating the system in accordance with the method.

In a yet further embodiment, the method comprises: receiving a signal indicating that the audiovisual work could not be viewed during a viewing window time period; and cancelling electronically a payment for the sale of the hard copy of the audiovisual work coupled with an immediate viewing of the audiovisual work.

In a yet further embodiment, the method comprises: receiving electronically a designation of a format for the hard copy of the audiovisual work; and including information on the designation of the format in the instruction sent to the fulfillment entity.

In a further embodiment, a video-on-demand method for performance by an entity that is not an audiovisual control entity or an audiovisual delivery entity, comprising: negotiating a different respective contract with each of one or more audiovisual control entities, wherein the respective contract with each of the one or more respective audiovisual control entities obtains a right with respect to each of a plurality of audiovisual works controlled by the respective audiovisual control entity, to offer a sale of a hard copy of the respective audiovisual work only when coupled with a substantially immediate viewing of the respective audiovisual work; negotiating a different respective contract with each of one or more respective audiovisual delivery entities, wherein the respective contract for each of the one or more respective audiovisual delivery entities provides a right to offer to subscribers of the respective audiovisual delivery entity a sale of the hard copy of the audiovisual work only if sold in combination with a substantially immediate viewing of the audiovisual work; receiving electronically information indicating a sale to one of the subscribers of one of the audiovisual delivery entities of the sale of the hard copy of the audiovisual work coupled with the substantially immediate viewing of the audiovisual work; accumulating over a period of time information on sales of a hard copy of one or more other audiovisual works controlled by the one audiovisual control entity coupled with a substantially immediate viewing of the one or more other audiovisual works; calculating electronically a monetary amount owed to the one audiovisual control entity based on the information about the sales; communicating monetary amount data relating to the monetary amount owed to the one audiovisual control entity; calculating electronically a monetary amount owed by the audiovisual delivery entity based on the information about the sales; and communicating monetary amount data relating to the monetary amount owed to the audiovisual delivery entity.

### BRIEF DESCRIPTION OF THE DRAWINGS

FIG. 1 is a schematic block diagram of an embodiment of the invention.

FIG. 2 is a flowchart of an embodiment of the invention.

FIG. 3 is a flowchart of a further embodiment of the invention.

FIG. 4 is a schematic block diagram of one embodiment for implementing an aspect of the invention.

FIG. 5 is a flowchart of an order life cycle for one embodiment of the invention.

### DETAILED DESCRIPTION OF THE EMBODIMENTS

### Definitions:

“Audiovisual” means a audiovisual work, television program or other moving picture with audio work.

“Audiovisual delivery entity” or “AV delivery entity” means a cable, satellite, Internet or other audiovisual delivery system involving electronic transport of a signal containing the audiovisual work.

“Audiovisual control entity” or “AV control entity” means a audiovisual work studio, audiovisual work or television producer, Internet entity, or any other entity that is capable of transferring a right to sell of a hard copy of the audiovisual work coupled with a substantially immediate viewing of the audiovisual.

“Substantially immediate viewing” means immediately after a sale has been approved or within a short period of time after the sale has been approved, such as 30 seconds or one minute or 5 minutes after the sale approval.

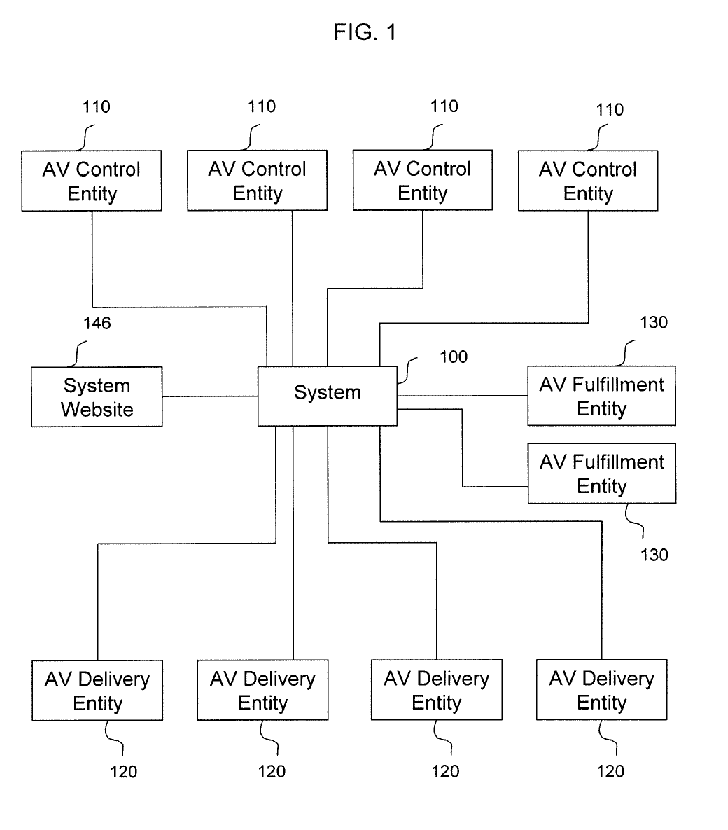

Referring now to FIG. 1, a schematic diagram of one embodiment of the invention is illustrated. A system 100 is provided for negotiating a different respective contract with each of one or more audiovisual control entities 110, wherein the respective contract with each of the one or more respective audiovisual control entities obtains a right with respect to each of a plurality of audiovisual works controlled by the respective audiovisual control entity, to offer a sale of a hard copy of the respective audiovisual work only when coupled with a substantially immediate viewing of the respective audiovisual work. The system 100 may be implemented in one embodiment by one or more computers. By “different” contracts is meant that the contract may differ by as little as different parties with substantially the same terms, or may have substantially different terms. The audiovisual control entity would be an entity that is capable of transferring a right for a substantially immediate viewing of an audiovisual work coupled with a sale of a hard copy of the audiovisual work, such as a movie or television studio, an audiovisual work or television producer, an Internet entity, or any other entity with such rights. FIG. 1 further includes one or more audiovisual (AV) delivery entities 120, and one or more audiovisual (AV) fulfillment entities 130.

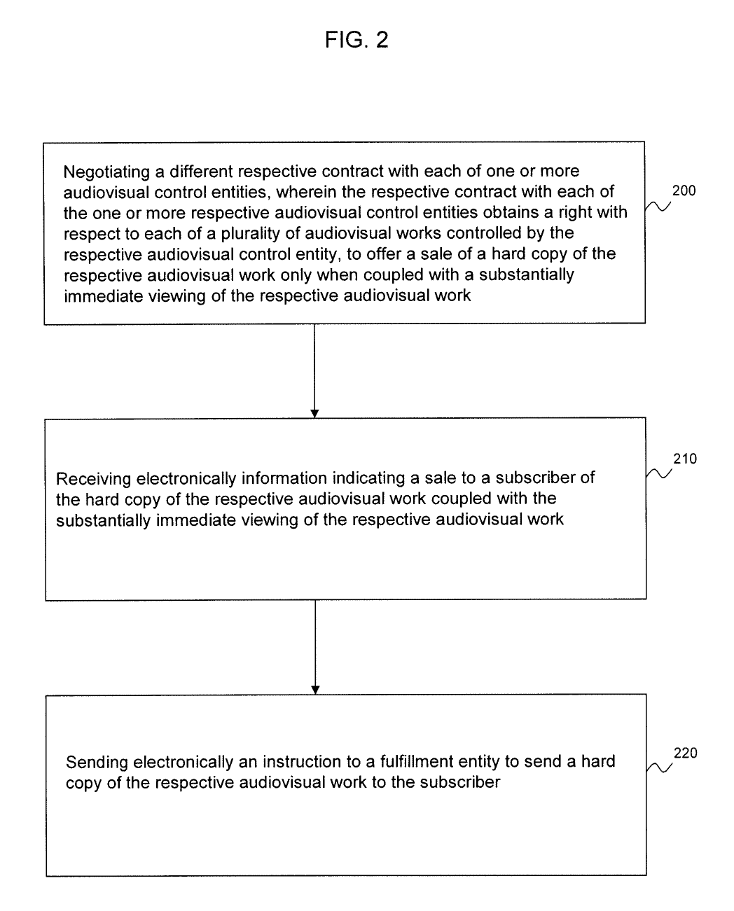

A flowchart for one embodiment for operating the invention is illustrated in FIG. 2. An operation 200 of negotiating a different respective contract with each of one or more audiovisual control entities 110 is shown in the figure. This negotiation operation may be implemented by computer in accordance with certain prescribed parameters, or may be implemented manually via a face-to-face negotiation of contract terms between the company operating the system and the AV control entity.

Referring to block 210, this comprises the operation of receiving electronically information indicating a sale to a subscriber of a hard copy of a respective audiovisual work coupled with the substantially immediate viewing of the respective audiovisual work. In one embodiment, this may comprise an electronic message from a cable company, satellite company, or Internet or other audiovisual delivery system 120 indicating such sale and identifying the audiovisual work. In another embodiment, the system may comprise an audiovisual delivery system 120. In such an embodiment, the information received electronically may comprise electronic signals received from a subscriber indicating an acceptance of an offer to purchase a hard copy of the respective audiovisual work coupled with a substantially immediate viewing of the respective audiovisual work.

Referring to block 220, this comprises the operation of sending electronically or manually an instruction to a fulfillment entity 130 to send a hard copy of the respective audiovisual work to the subscriber.

In one embodiment, the method may be operated by a system that is an audiovisual delivery entity. In a different embodiment, the method may be operated by an entity that is not an audiovisual delivery entity and may further comprise negotiating a different (at least in sense of different parties) respective contract with each of one or more respective audiovisual delivery entities, wherein the respective contract for each of the one or more respective audiovisual delivery entities provides a right to offer to subscribers of the respective audiovisual delivery entity a sale of a hard copy of an audiovisual work only if sold in combination with a substantially immediate viewing of the audiovisual work.

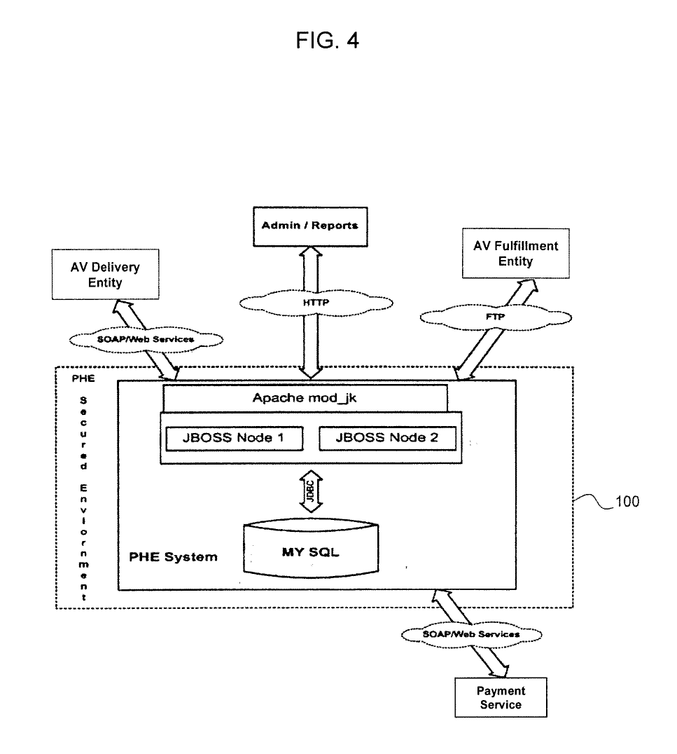

FIG. 4 represents the high level architecture for one embodiment of the system 100. The system 100 in one embodiment may be implemented using object-oriented design patterns. For example, the system may be developed in Java J2EE technologies using JDK 1.5 version. The system 100 may use MySQL 5.0 and JBoss 4.0.5 as database and application servers, respectively. The JBoss implementation may be clustered on two separate nodes for load balancing and failover using Apache mod_jk. Web service interfaces may use the Axis 1.2 stack (an open source web services stack).

The logical design for the system 100 may comprise in one embodiment, a presentation layer, a Web services layer, an aspect layer, an application layer and a data services layer. In one embodiment, the presentation layer may comprise a presentation layer using JSP 2.0 (Java Server Pages) and use Struts 1.3.5 as an underlying MVC (model view controller) framework. All of the web interfaces may be built in to this layer. All secure interfaces may use a basic user name and password authentication and may in one embodiment use HTTPS as the communication protocol.

The Web services layer for the system may use in one embodiment Axis 1.2 for Web services interfaces deployed on the JBoss application server. Services such as MSO Order, Order status; eWallet to name a few, may be packaged and made fully hot-deployable. All Web service interactions between the system 100, the audiovisual delivery entity, and a payment service provider may, in one embodiment, use message authentication code (MAC) and password based sender/recipient authentication for message authentication.

The aspect layer for the system 100 in one embodiment may be based on the Aspect-Oriented Programming (a type of open source programming) model, and may comprise a logging function and an auditing function. The system 100 may use Log4j 1.2.9 (an open source logging tool) and may have at least the following appenders used at appropriate places.

Entry in log file (Fileappenders)

Entry in DB log table (JDBCappenders)

Email Alert (SMTPappenders)

All messages send and received by system 100 from AV delivery entity sources, subscribers, and fulfillment entities may be logged for further auditing and reporting functions in a separate database. Important events such as order status changes may be logged with a timestamp for auditing and reporting purposes.

The application layer includes the business logic and may contain the core system 100 API. Transactions of real time order processing, authentication, AV fulfillment batch processing may be handled in this layer using data transfer objects (DTOs). The application layer may use the aspect layer for logging and auditing functions.

The data services layer stores interactions with a database (not shown) for the system and may be comprised of Java DAOs (data access objects). The data services layers maintains consistency of interactions made to the database. Note that a J2EE architecture, which produces one or more SQL queries for each data object access, may saturate the database server in a transaction-intensive application. This saturation bottleneck may be addressed by implementing an object caching mechanism for master entity objects such as customer and credit card.

Note that the system 100 further includes a message generator module that generates one or more messages. Messages may, for example, be in the form of e-mail, facsimile, text message or other form of communication.

Additionally, the system 100 may include a reporting system module for monitoring and generating reports on various aspects of the operation. Additionally, the system may include a display interface with local and/or remote monitoring. Additionally, the system 100 may include communications and miscellaneous interfaces. The communications interface could connect to one or more electronic communications networks.

Some of the main data flows in the system comprise:

Fulfillment Entity Data import data;

Pre-authorization web site data to pre-approve a payment vehicle;

Real-time Order Processing data;

Batch order processing data

Check Order status data;

Payment Settlement data;

Administration activities data.

i. Performance and Scalability

HTTP session replication is used with JBoss Application Server (an open source application server) in one embodiment. In the event that one of the nodes in the system crashes, another node in the cluster will be able to recover and run the application. Session state replication may be configured and enabled as a default option in JBoss deployment. Once enabled, the application and its session state are replicated across all JBoss instances in the cluster which would take care of fail over. Load balancing may be achieved using Apache Mod_jk (an open source library that supports clustering) with sessions.

ii. Clustering

The system cluster in one embodiment may have two nodes. In a JBoss cluster, a node is a JBoss server instance. To build a cluster, several JBoss instances are grouped together. Nodes can be added to or removed from clusters at any time. When the node is started, the cluster is created. A cluster is removed when all of its nodes are removed. The system 100 on JBoss may include clustering support. For the Nodes to form a different cluster a Partition name of PHEPartition may be used, with nodes with the same partition name joining the PHEPartition cluster. As per the load on the system, different clusters on a same network with individual names and partitionconfig elements may be used to enable the system 100 to scale up with minimal code changes to the application.

iii. Load Balancing and Fail Over

A system 100 load-balancer tracks HTTP requests and, depending on the request to which it is linked, dispatches the request to the appropriate node. The load balancer is required to process all requests and dispatch them to server nodes in the cluster. The load balancer is typically part of the cluster. It understands the cluster configuration as well as failover policies. As Load-balancing is not handled by JBoss itself, it uses Apache web server and Mod_jk plug-in software. Mod_jk is designed to allow forward requests from Apache to a Servlet container (JBoss Instances). The system 100 may use an Apache web server configured with mod_jk to detect and send requests to the cluster. This would enable requests to be balanced across the nodes in the cluster in the Partition name, PHEPartition. Configured Apache would recognize if any node is dead in the cluster, and will stop sending requests to that node and forward those requests to other live nodes in the cluster.

iv. Transactions

In one embodiment, the system 100 may use a transaction oriented system to make use of XA transactions (transactions generated by MySQL) available in a MySQL engine. An XA interface to a MySQL server comprises SQL statements that begin with an XA keyword. Currently, among MySQL Connectors, MySQL Connector/J 5.0.0 supports XA directly (by means of a class interface that handles the XA SQL statement interface for client). XA supports distributed transactions; that is, the ability to allow multiple separate transactional resources to participate in a global transaction. A global transaction involves several actions that are transactional in themselves, but that all must either complete successfully as a group, or all must be rolled back as a group. In essence, this extends ACID (atomicity, consistency, isolation, durable) properties “up a level” so that multiple ACID transactions can be executed in concert as components of a global operation that also has ACID properties. For a distributed transaction, a SERIALIZABLE isolation level is required to achieve ACID properties and a REPEATABLE READ for a non-distributed transaction.

The system 100 in one embodiment acts as an integration point that combines a messaging service with an RDBMS (relational database management system). The system 100 may be designed to ensure that transactions dealing with message sending, retrieval, and processing such as order status, order settlement, order acknowledgements, to name a few, also involve a transactional database, and all happen in a global transaction like a “transactional email.”

v. Auditing

In one embodiment, the system 100 may log all important events in the flow for auditing purposes. This may come above system logging activities. By way of example, a Log4J JDBCAppender (a Java database connection) may be used for auditing purposes.

2. Data Design

a. Data Entities

The system 100 may be supported in one embodiment by core and log data entities. Core data entities store user and transactional data that are carried in the system. LOG data entities store all messages requested and received between the system 100 and AV delivery entity systems, subscriber systems, and fulfillment entities systems with a time and date stamp. These log tables may have the attributes of the respective messages and need not contain any relations among them. The following are the high level data entities of Core.

i. Organization Data Entity

Organization entity stores information about the organizations participating in the system 100, e.g., the audiovisual delivery entities, payment service providers, banks, fulfillment entities, and audiovisual control entitites.

ii. AV Delivery Data Entity

AV delivery data entity stores information about the particular AV delivery entities participating in the system 100, who are other than subscribers. AV delivery data entities cannot exist in the system with out affiliation to an AV delivery entity organization.

iii. Roles Data Entity

The Role Entity stores information about roles that can be assigned to AV deliveries in the system to facilitate role-based access to various levels of the system. Roles are organization type specific such as audiovisual delivery entity specific admin and system admin.

iv. Subscriber Data Entity

The Customer entity stores information about the customers placing orders in the system. Customers are audiovisual delivery entity specific and are linked to an organization.

v. AV Fulfillment Data Entity

An AV fulfillment data entity stores information about the data transmitted from the AV fulfillment entity 130 to the system 100. Data in this entity is maintained AS-IS received from the AV fulfillment entity 130 and forms the basis for the system product. AV fulfillment data in one embodiment would come with WMS_ID as a unique identifier of the product in the system. Note that the term “product” comprises a particular embodiment of an audiovisual title. For example, for a given movie, there may be a version 1 which is rated, a version 2 which is unrated, a collector's edition, a director's cut edition, a wide screen edition, a standard screen edition, an HD DVD edition, a BlueRay Edition, to name a few. The term “product” identifies one of those versions or editions.

vi. System Product Data Entity

The system Product entity stores information about system product catalog. Data for the Product data entity is derived from the AV Fulfillment Data with additional attributes filled in by appropriate AV delivery entities. The system Product would come with a system Product ID. WMS_ID of the AV fulfillment entity would be optionally propagated to the system product data item.

vii. System Bundle Data Entity

The system Bundle data entity would store information about bundles created in system product. There can be many titles created as a bundle and would have bundle_Id as a unique Id. The bundle concept is for aggregating orders for one customer over the course of a time period, e.g., a day, to facilitate implementation of a shipping discount. For example, if one person ordered three DVD's in three separate order during the course of a day, these orders would be bundled together and a reduced shipping charge would be applied.

viii. AV Delivery Entity Product Data Entity

The AV Delivery Entity Product data entity stores information about the bundles. The AV Delivery Entity Product data Entity stores additional information such as audiovisual delivery entity Price, lock status, etc.

ix. AV Delivery Entity Order Data Entity

The AV Delivery Entity Order entity stores information about the audiovisual delivery entity order. An AV Delivery Entity Order forms the main transaction entity in the system. All orders are AV delivery entity specific and are linked to the customer and AV delivery entity product.

x. AV Delivery Entity Order Batch Data Entity

The AV Delivery Entity Order Batch Data Entity stores information about the batch data that is being transmitted to the AV fulfillment entity 130 with a time and date stamp.

xi. AV Delivery Entity Order Response Data Entity

The AV Delivery Entity Order Response Data Entity stores information about a response message from the AV fulfillment entity 130. This entity would be linked to the AV delivery entity Order, batch and subscriber.

xii. Other Data Entities

Apart from above data entities, entities such as title, credit card, order detail entities may also be created.

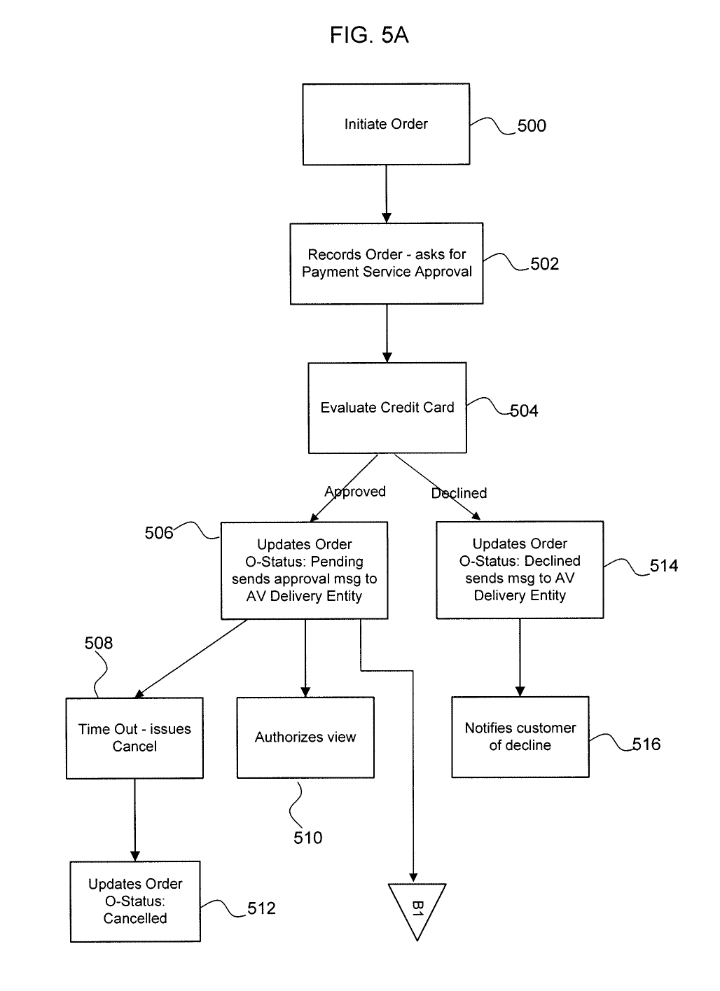

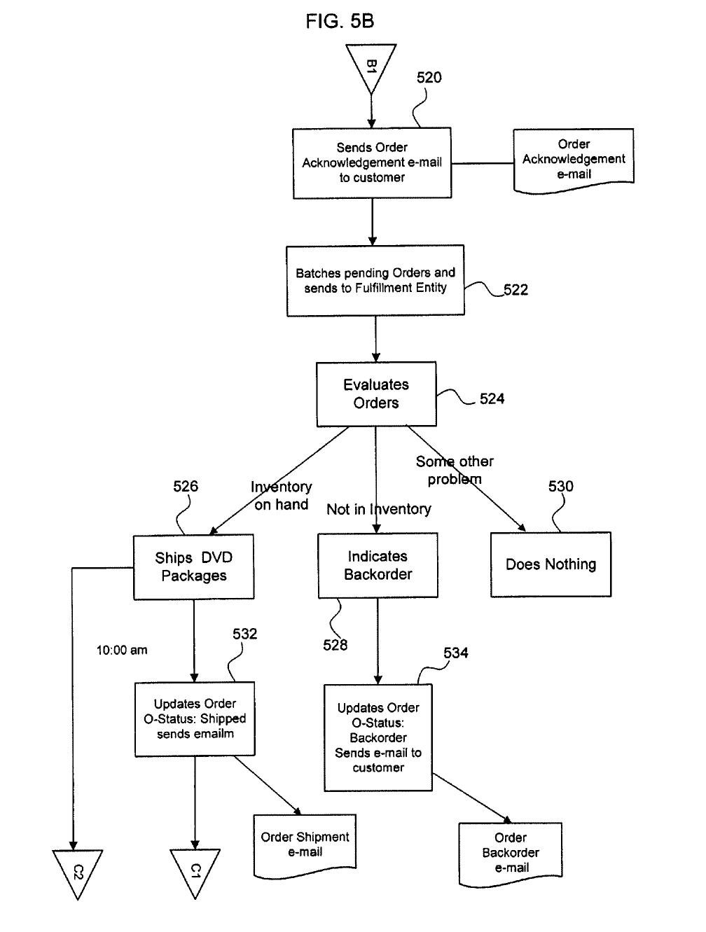

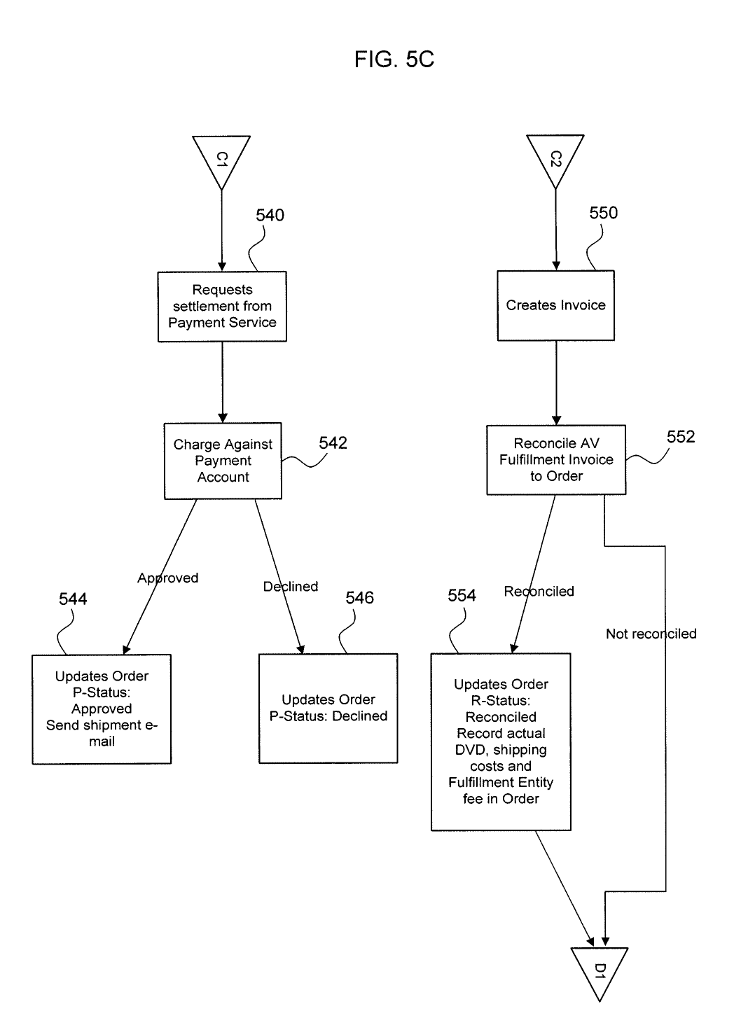

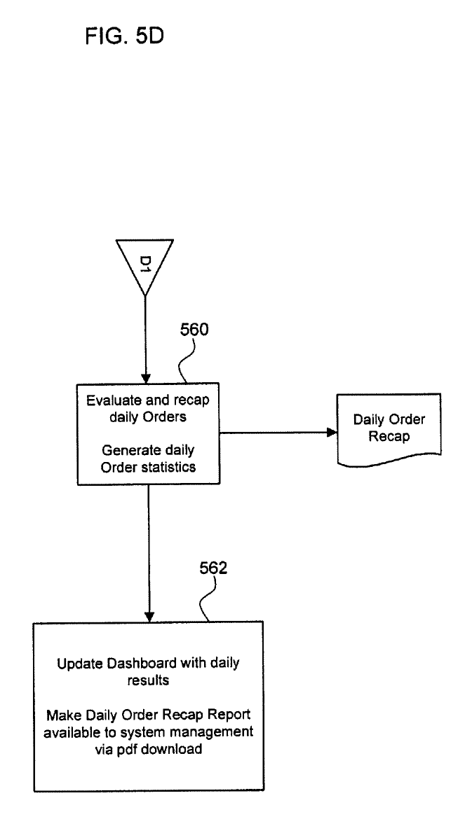

Referring now to FIG. 5, an operation flowchart for an order life cycle in accordance with one embodiment of the invention is shown. Block 500 comprises the operation of receiving an electronic signal initiating an order. In one embodiment, a subscriber of an audiovisual delivery entity 120 indicates that he/she wishes to purchase a hard copy of an audiovisual work coupled with an immediate viewing of the audiovisual work. For example, the subscriber may press a button or click on an icon on a screen with their remote control to commit to purchase a DVD of a movie coupled with an immediate viewing of the movie. A signal indicating this purchase is received by the system in block 500. Note that in one embodiment, the receipt of a signal indicating a sale means that a selection of an audiovisual work has been received by the AV delivery entity or a third party operating the system, a confirmation of the subscriber identity making the selection, for example a PIN, is received, a signal indicating that a “purchase” button has been pressed, and a confirmation signal of the purchase has been received by the subscriber pushing on or clicking on the purchase button again.

Block 502 records the order for the hard copy of the specific audiovisual work coupled with an immediate viewing of the audiovisual work. In one embodiment, a request from a payment service such as PayPal™ or a credit or debit card company is initiated. In another embodiment, the credit card, debit card or other payment vehicle is already on file in the system and is accessed.

In block 504 the credit card or other payment vehicle is evaluated by the system or a third party, or the payment information and subscriber history is evaluated in the system records, and based on this evaluation, the order is either approved or declined. Such as evaluation may comprise receiving a response from the credit or debit card company that a particular card it valid and that they will honor it. In some instances, it may include a determination that there is a sufficient balance in an account to cover the transaction.

In block 506 after an approval, the order status is updated in the system database as “approved.” An electronic message of approval is sent to the AV delivery entity 120 in the case where the system 100 is separate from the AV delivery entity 120. In block 510, the AV viewing is authorized in the AV delivery system 120. Alternatively, if the AV delivery system 120 does not receive an approval message in a certain period of time, it times out and the order is cancelled in block 512.

In block 514 if the order is declined, a message is sent to the AV delivery entity 120 declining the order and an electronic message is sent or displayed to the subscriber notifying of the declined order.

In block 520, an order acknowledgement communication, such as an email, is transmitted to the subscriber. Additionally, information is electronically recorded for use in calculating a royalty to be paid to the AV control entity.

In block 522 the system 100 accumulates orders over a period of time, batches the orders, and then transmits the orders in batch to the AV fulfillment entity 130 to initiate fulfillment of the DVD or other hard copy to the subscriber. Alternatively, each order may be individually transmitted to the AV fulfillment entity 130 as they are received.

In block 524 the AV fulfillment entity 130 evaluates the received orders and determines if the hard copy of the audiovisual work is on hand in inventory or is easily accessible. Block 526 represents the AV work being in inventory or easily accessible, and the AV work, e.g., a DVD, is shipped out. In block 532, the order status in the system database is then updated to “shipped.”

Block 528 indicates that the AV work is not in inventory or accessible, and the AV work is placed on back order. In block 534, the order status in the system database is then updated to “backorder,” and an email or other electronic communication or a letter is sent notify the subscriber of the backorder. Block 530 indicates another type of problem which prevents the fulfillment of the hard copy.

Block 540 comprises the system 100 requesting payment from the payment service where that payment option is being used. Block 542 comprises an attempt to place a charge against a credit card account or some other payment vehicle. Block 544 comprises an electronic update to the database to indicate that a payment status is “approved.” Alternatively, block 546 comprises an electronic update to the database to indicate that a payment status is “declined.”

In block 550 an invoice is created by the AV fulfillment entity 130. In block 552 the system 100 reconciles electronically the AV fulfillment invoice with the order. In block 554 for the case where there is an reconciliation, the order status in the system database is electronically updated to “reconciled,” and a record of the actual AV work shipped is made, along with shipping costs and the Av fulfillment entity fee.

In block 560 the system 100 evaluates and recaps the orders received during a time period, e.g., a day, and generates statistics for that time period. In block 562 an electronic dashboard is updated with the order results from the period. An order recap report may be generated an made accessible on line via a PDF download, or may be transmitted electronically or mailed.

In a further embodiment, a single payment vehicle approval process is not used as a main process where the subscriber has an account in good standing. Rather, audiovisual delivery entity subscriber purchases of the DVD and video-on-demand combination are accumulated and processed and/or forwarded for processing in batch.

In one embodiment, Orders may be submitted via SOAP (web service) calls to the system 100. The order submission interface in the system may synchronously process the order and return a SOAP response indicating the success or failure of the order acceptance. Customer attributes received from the audiovisual delivery entity 120 would be saved to the database in the system 100.

In a further embodiment, the method comprises negotiating a different (at least in sense of different parties) respective contract with each of one or more respective audiovisual delivery entities, wherein the respective contract with respect to each of the one or more respective audiovisual delivery entities provides a right to offer to subscribers of the respective audiovisual delivery entity a sale of the hard copy of the audiovisual work only if sold in combination with a substantially immediate viewing of the audiovisual work.

In a further embodiment, the method may comprise determining electronically if a hard copy of the audiovisual work is available from one or more fulfillment entities within a period of time; and, preventing electronically the sale to a subscriber of the hard copy of the audiovisual work coupled with the substantially immediate viewing of the audiovisual work if the hard copy of the audiovisual work is not available for fulfillment within the period of time.

In a yet further embodiment, the method may comprise operating the method after a plurality of the audiovisual works were released for a first theatrical run some period of time before the sale.

In a yet further embodiment, the method may comprise limiting the substantially immediate viewing to a single viewing during an immediate viewing availability period.

In a yet further embodiment, the method is operated when a plurality of the audiovisual works are released for individual hard copy sales.

In a yet further embodiment, the method comprises accumulating sales of a plurality of audiovisual works over a period of time; and generating and sending information on the accumulated sales of the plurality of audiovisual works to the fulfillment entity 130 at one time.

In a yet further embodiment, the method comprises receiving electronically a message indicating that the subscriber has requested to buy a hard copy of the audiovisual work coupled with the sale of a substantially immediate viewing of the audiovisual work; and sending electronically or having sent electronically a message either approving or denying the sale of the hard copy and the immediate viewing of the audiovisual work based on a criterion. In one embodiment, the criterion is a credit approval. In another embodiment, the criterion comprises a rating on a potential of the subscriber for unauthorized copying.

In a yet further embodiment, the method comprises sending the audiovisual work to a vendor to have copyprotect software added to an electronic file containing the audiovisual work.

In a yet further embodiment, the method comprises accessing electronically a database of audiovisual delivery subscribers and determining other audiovisual works that may be of interest to the subscriber based on a criterion. In one embodiment, the criterion is one or more audiovisual works viewed or purchased in the past by the subscriber.

In a yet further embodiment, the method comprises uploading electronically to the audiovisual delivery entity an advertisement for playing to one or more subscribers.

In a yet further embodiment, the method comprises accumulating over a period of time information on sales of hard copies of the audiovisual works coupled with an immediate viewing of the audiovisual works; calculating electronically a monetary amount owed to the audiovisual control entity based on the information about the sales; and communicating monetary amount data relating to the monetary amount owed to the audiovisual control entity.

In a yet further embodiment, the method comprises accumulating over a period of time information on sales of hard copies of the audiovisual works coupled with an immediate viewing of audiovisual works; calculating electronically a monetary amount owed by the audiovisual delivery entity based on the information about the sales; and communicating monetary amount data relating to the monetary amount owed.

In a yet further embodiment, the method comprises creating an electronic log of sales of hard copies of the audiovisual works coupled with an immediate viewing of the audiovisual works; and generating and sending or allowing access to an electronic report based on the log.

In a yet further embodiment, the method comprises maintaining or having maintained an electronic database containing subscriber profiles, with each subscriber profile comprising a plurality of parameters. By way of example, the subscriber profile may comprise a subscriber name, shipping address, credit card, PIN, audiovisual format, language, to name a few.

In a yet further embodiment, the method comprises maintaining or having maintained a Website with one or more Web pages displaying a plurality of audiovisual works available for a sale of a hard copy of the audiovisual work coupled with an immediate viewing of the audiovisual work; with the Web page configured to allow access and updating of an electronic profile of the subscriber after appropriate authentication. In one embodiment, a customized Web page is generated for each subscriber displaying audiovisual works that may be of interest to that subscriber, and a past history of purchases. The subscriber may be identified to the system for example by his ID and password. In one embodiment, the Web page and list of audiovisual works and purchase history may be generated in immediate response to the subscriber connecting in to the system server.

In a yet further embodiment, the method comprises the Web page displaying a purchase indicator that allows a subscriber to buy a hard copy of the audiovisual work coupled with an immediate viewing of the audiovisual work.

In a yet further embodiment, the method comprises receiving electronically one or more shipping addresses from a subscriber to facilitate delivery of a gift of the hard copy of the audiovisual work.

In a yet further embodiment, the method comprises providing electronically tracking data for display relating to delivery of the hard copy of the audiovisual work to the subscriber or another.

In a yet further embodiment, the method comprises providing electronically an out-of-stock message to the subscriber.

In a yet further embodiment, the method comprises determining electronically from each of a plurality of fulfillment entities one from the group of cost of the hard copy of the audiovisual work and in-stock information for the audiovisual work; and selecting one of the fulfillment entities to send the instruction to provide the hard copy of the audiovisual work.

In a yet further embodiment, the method comprises receiving electronically a list comprising a plurality of audiovisual works now available for sale of a hard copy of the audiovisual work coupled with a substantially immediate viewing of the audiovisual work; and sending electronically less than the entire list of the audiovisual works now available to the audiovisual delivery entity.

In a yet further embodiment, there are a plurality of audiovisual work control entities, with a different contract negotiated with each of these plurality of audiovisual work control entities; and wherein there are a plurality of cable and/or satellite AV delivery entities, with a different contract negotiated with each of these cable or satellite entities.

In a yet further embodiment, the method comprises maintaining or having maintained a Website with one or more Web pages displaying a plurality of audiovisual works available for a sale of a hard copy of the audiovisual work coupled with an immediate viewing of the audiovisual work; and with the Web page configured to provide information to permit activating an electronic file disposed in a hard copy of the audiovisual work.

In a yet further embodiment, the method comprises maintaining or having maintained a Website with one or more Web pages displaying a plurality of audiovisual works available for a sale of a hard copy of the audiovisual work coupled with an immediate viewing of the audiovisual work; and the Web page configured for the sale and download of an electronic copy of the audiovisual work.

In a yet further embodiment, the method comprises maintaining or having maintained a Website with one or more Web pages displaying a plurality of audiovisual works available for a sale of a hard copy of the audiovisual work coupled with an immediate viewing of the audiovisual work; and a purchase indicator that allows a subscriber to buy the sale of a hard copy of the audiovisual work coupled with the immediate viewing of the audiovisual work.

In a yet further embodiment, the method comprises receiving a signal indicating that the audiovisual work could not be viewed during a viewing window time period; and cancelling electronically a payment for the sale of the hard copy of the audiovisual work coupled with an immediate viewing of the audiovisual work. Note that the signal indicating that the audiovisual work could be viewed may be caused by a technical problem at the AV delivery entity, or in some embodiments, by a technical problem with the subscriber's viewing equipment. The cancellation may further include a cancellation of the order of the hard copy to the AV fulfillment entity.

In a yet further embodiment, the method comprises receiving electronically a designation of a format for the hard copy of the audiovisual work; and including information on the designation of the format in the instruction sent to the fulfillment entity.

In a yet further embodiment, the method comprises agreeing in the contract to provide to the audiovisual control entity a right to purchase an ownership interest of a company operating the system in accordance with the method.

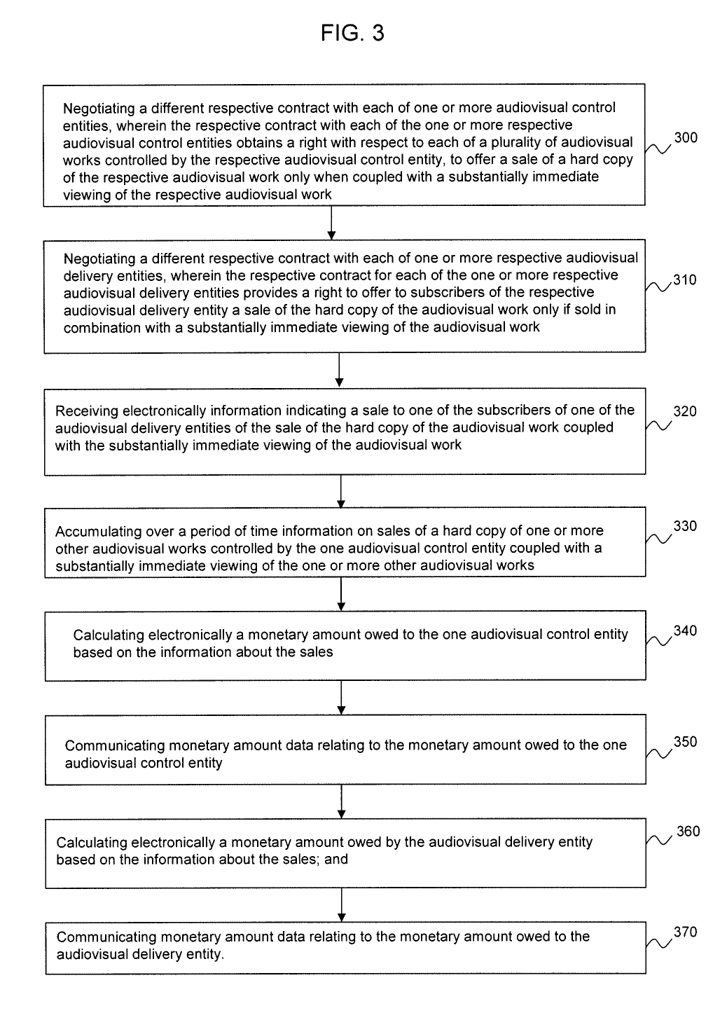

Referring to FIG. 3, a further embodiment of the invention is disclosed. Block 300 comprises negotiating a different respective contract with each of one or more audiovisual control entities, wherein the respective contract with each of the one or more respective audiovisual control entities obtains a right with respect to each of a plurality of audiovisual works controlled by the respective audiovisual control entity, to offer a sale of a hard copy of the respective audiovisual work only when coupled with a substantially immediate viewing of the respective audiovisual work.

Block 310 comprises negotiating a different respective contract with each of one or more respective audiovisual delivery entities, wherein the respective contract for each of the one or more respective audiovisual delivery entities provides a right to offer to subscribers of the respective audiovisual delivery entity a sale of the hard copy of the audiovisual work only if sold in combination with a substantially immediate viewing of the audiovisual work.

Block 320 comprises receiving electronically information indicating a sale to one of the subscribers of one of the audiovisual delivery entities of the sale of the hard copy of the audiovisual work coupled with the substantially immediate viewing of the audiovisual work.

Block 330 comprises accumulating over a period of time information on sales of a hard copy of one or more other audiovisual works controlled by the one audiovisual control entity coupled with a substantially immediate viewing of the one or more other audiovisual works.

Block 340 comprises calculating electronically a monetary amount owed to the one audiovisual control entity based on the information about the sales.

Block 350 comprises communicating monetary amount data relating to the monetary amount owed to the one audiovisual control entity.

Block 360 comprises calculating electronically a monetary amount owed by the audiovisual delivery entity based on the information about the sales.

Block 370 comprises communicating monetary amount data relating to the monetary amount owed to the audiovisual delivery entity.

Those skilled in the art will appreciate that the invention may be practiced in network computing environments with many types of computer system configurations, including personal computers, hand-held devices, mobile telephones, multi-processor systems, microprocessor-based or programmable consumer electronics, network PCs, minicomputers, mainframe computers, to name a few. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing portions of the invention includes a general purpose or special purpose computing device, including a processing unit, a system memory, and a system bus that couples various system components including the system memory to the processing unit. The system memory may include read only memory (ROM) and random access memory (RAM). The computing device may also include a magnetic hard disk drive for reading from and writing to a magnetic hard disk, a magnetic disk drive for reading from or writing to a removable magnetic disk, and an optical disk drive for reading from or writing to removable optical disk such as a DVD-ROM, CD-ROM or other optical media. The drives and their associated computer-readable media provide nonvolatile storage of computer-executable instructions, data structures, program modules and other data for the computing device.

Embodiments within the scope of the present invention also include computer-readable media for carrying or having computer-executable instructions or data structures stored thereon, also known as software. Such computer-readable media can be any available media, which can be accessed by a general purpose or special purpose computer. By way of example, and not limitation, such computer-readable media can comprise RAM, ROM, EPROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions. Computer-executable instructions may also be properly termed “software” as known by those of skill in the art.

Program code or software means comprising one or more program modules may be stored on the hard disk, magnetic disk, optical disk, ROM or RAM, and may include an operating system, one or more application or software programs, other program modules, and program data. In some embodiments, the program(s) may be deployed and accessible on the Internet and operate within Web browsers.

Embodiments of the invention may operate in a networked environment using logical connections to one or more computers having processors. Logical connections may include a local area network (LAN) and a wide area network (WAN) that are presented here by way of example and not limitation. Such networking environments are commonplace in office-wide or enterprise-wide computer networks, intranets (a network belonging to an organization, usually a corporation, accessible only by the organization's members, employees, or others with authorization). An intranet's Web sites look and act just like any other Web sites. Like the Internet itself, intranets are used to share information.

Embodiments of the invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular data types. Multi-threaded applications may be used, for example, based on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or manual operations.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A video-on-demand method for a system that is not an audiovisual control entity, comprising:
negotiating a different respective contract with each of one or more audiovisual control entities, wherein the respective contract with each of the one or more respective audiovisual control entities obtains a right with respect to each of a plurality of audiovisual works controlled by the respective audiovisual control entity, to offer a sale of a hard copy of the respective audiovisual work only when coupled with a substantially immediate viewing of the respective audiovisual work;
receiving electronically information indicating a sale to a subscriber of the hard copy of the respective audiovisual work coupled with the substantially immediate viewing of the respective audiovisual work;
generating an electronic record of the sale; and
sending an instruction to a fulfillment entity to send a hard copy of the respective audiovisual work to the subscriber.

2. The method as defined in claim 1, wherein the method is operating a system that is not an audiovisual delivery entity, and further comprising:
negotiating a different respective contract with each of one or more respective audiovisual delivery entities, wherein the respective contract with respect to each of the one or more respective audiovisual delivery entities provides a right to offer to subscribers of the respective audiovisual delivery entity a sale of the hard copy of the audiovisual work only if sold in combination with a substantially immediate viewing of the audiovisual work.

3. The method as defined in claim 1, further comprising:
determining electronically if a hard copy of the audiovisual work is available from one or more fulfillment entities within a period of time; and
preventing electronically the sale to a subscriber of the hard copy of the audiovisual work coupled with the substantially immediate viewing of the audiovisual work if the hard copy of the audiovisual work is not available for fulfillment within the period of time.

4. The method as defined in claim 1, further comprising:
determining electronically from each of a plurality of fulfillment entities one from the group of cost of the hard copy of the audiovisual work and in-stock information for the audiovisual work; and
selecting one of the fulfillment entities to send the instruction to provide the hard copy of the audiovisual work.

5. The method as defined in claim 1, wherein a plurality of the audiovisual works were released for a first theatrical run some period of time before the sale.

6. The method as defined in claim 1, wherein the substantially immediate viewing is limited to a single viewing during an immediate viewing availability period.

7. The method as defined in claim 1, wherein a plurality of the audiovisual works were released for individual hard copy sales.

8. The method as defined in claim 1, further comprising accumulating sales of a plurality of audiovisual works over a period of time; and
wherein the sending step comprises generating and sending information on the accumulated sales of the plurality of audiovisual works to the fulfillment entity at one time.

9. The method as defined in claim 1, further comprising:
receiving electronically a message indicating that the subscriber has requested to buy a hard copy of the audiovisual work coupled with the sale of a substantially immediate viewing of the audiovisual work; and
sending electronically or having sent electronically a message either approving or denying the sale of the hard copy and the immediate viewing of the audiovisual work based on a criterion.

10. The method as defined in claim 9, wherein the criterion is a credit approval.

11. The method as defined in claim 8, further comprising:
sending the audiovisual work to a vendor to have copyprotect software added to an electronic file containing the audiovisual work.

12. The method as defined in claim 1, further comprising:
accessing electronically a database of audiovisual delivery subscribers and determining other audiovisual works that may be of interest to the subscriber based on a criterion.

13. The method as defined in claim 12, wherein the criterion is one or more audiovisual works viewed or purchased in the past by the subscriber.

14. The method as defined in claim 2, further comprising:
uploading electronically to the audiovisual delivery entity an advertisement for playing to one or more subscribers.

15. The method as defined in claim 1, further comprising:
accumulating over a period of time information on sales of hard copies of the audiovisual works coupled with an immediate viewing of the audiovisual works;
calculating electronically a monetary amount owed to the audiovisual control entity based on the information about the sales; and
communicating monetary amount data relating to the monetary amount owed to the audiovisual control entity.

16. The method as defined in claim 2, further comprising:
accumulating over a period of time information on sales of hard copies of the audiovisual works coupled with an immediate viewing of the audiovisual works;
calculating electronically a monetary amount owed by the audiovisual delivery entity based on the information about the sales; and
communicating monetary amount data relating to the monetary amount owed to the audiovisual delivery entity.

17. The method as defined in claim 1, further comprising:
creating an electronic log of sales of hard copies of the audiovisual works coupled with an immediate viewing of audiovisual works; and
generating an electronic report based on the log.

18. The method as defined in claim 1, further comprising:
maintaining or having maintained an electronic database containing subscriber profiles, with each subscriber profile comprising a plurality of parameters.

19. The method as defined in claim 1, further comprising:
maintaining or having maintained a Website with one or more Web pages displaying a plurality of audiovisual works available for a sale of a hard copy of the audiovisual work coupled with an immediate viewing of the audiovisual work; and
the Web page configured to allow access and updating of an electronic profile of the subscriber after appropriate authentication.

20. The method as defined in claim 19, further comprising the Web page configured to allow access to a purchase history for the subscriber after appropriate authentication.

21. The method as defined in claim 19, further comprising
the web page displaying a purchase indicator that allows a subscriber to buy a sale of a hard copy of the audiovisual work coupled with the immediate viewing of the audiovisual work.

22. The method as defined in claim 1, further comprising receiving electronically one or more shipping addresses from a subscriber to facilitate delivery of a gift of the hard copy of the audiovisual work.

23. The method as defined in claim 1, further comprising providing electronically tracking data for display relating to delivery of the hard copy of the audiovisual work.

24. The method as defined in claim 1, further comprising providing electronically an out-of-stock message to the subscriber.

25. The method as defined in claim 2, further comprising:
receiving electronically a list comprising a plurality of audiovisual works now available for sale of a hard copy of the audiovisual work coupled with substantially immediate viewing of the audiovisual work substantially immediate viewing coupled with sales of hard copies of the audiovisual works; and
sending less than the entire list of the audiovisual works now available to the audiovisual delivery entity.

26. The method as defined in claim 1, wherein there are a plurality of audiovisual control entities, with a different contract negotiated with each of these plurality of audiovisual work control entities; and
wherein there are a plurality of audiovisual delivery entities, with a different contract negotiated with each of these audiovisual delivery entities.

27. The method as defined in claim 1, further comprising:
maintaining or having maintained a Website with one or more Web pages displaying a plurality of audiovisual works available for a sale of a hard copy of the audiovisual work coupled with an immediate viewing of the audiovisual work; and the Web page configured to provide information to permit activating an electronic file disposed in a hard copy of the audiovisual work.

28. The method as defined in claim 1, further comprising:
maintaining or having maintained a Website with one or more Web pages displaying a plurality of audiovisual works available for a sale of a hard copy of the audiovisual work coupled with an immediate viewing of the audiovisual work; and the Web page configured for the sale and download of an electronic copy of the audiovisual work.

29. The method as defined in claim 1, further comprising:
maintaining or having maintained a Website with one or more Web pages displaying
a plurality of audiovisual works available for a sale of a hard copy of the audiovisual work coupled with an immediate viewing of the audiovisual work; and
a purchase indicator that allows a subscriber to buy the hard copy of the audiovisual work coupled with the immediate viewing of the audiovisual work.

30. The method as defined in claim 1, further comprising agreeing in the contract to provide to the audiovisual control entity a right to purchase an ownership interest of a company operating the system in accordance with the method.

31. The method as defined in claim 1, further comprising:
receiving a signal indicating that the audiovisual work could not be viewed during a viewing window time period; and
cancelling electronically a payment for the sale of the hard copy of the audiovisual work coupled with an immediate viewing of the audiovisual work.

32. The method as defined in claim 1, further comprising:
receiving electronically a designation of a format for the hard copy of the audiovisual work; and
including information on the designation of the format in the instruction sent to the fulfillment entity.

33. A video-on-demand method that is not an audiovisual control entity or an audiovisual delivery entity, comprising:
negotiating a different respective contract with each of one or more audiovisual control entities, wherein the respective contract with each of the one or more respective audiovisual control entities obtains a right with respect to each of a plurality of audiovisual works controlled by the respective audiovisual control entity, to offer a sale of a hard copy of the respective audiovisual work only when coupled with a substantially immediate viewing of the respective audiovisual work;
negotiating a different respective contract with each of one or more respective audiovisual delivery entities, wherein the respective contract for each of the one or more respective audiovisual delivery entities provides a right to offer to subscribers of the respective audiovisual delivery entity a sale of the hard copy of the audiovisual work only if sold in combination with a substantially immediate viewing of the audiovisual work;
receiving electronically information indicating a sale to one of the subscribers of one of the audiovisual delivery entities of the sale of the hard copy of the audiovisual work coupled with the substantially immediate viewing of the audiovisual work;
accumulating over a period of time information on sales of a hard copy of one or more other audiovisual works controlled by the one audiovisual control entity coupled with a substantially immediate viewing of the one or more other audiovisual works;
calculating electronically a monetary amount owed to the one audiovisual control entity based on the information about the sales;
communicating monetary amount data relating to the monetary amount owed to the one audiovisual control entity;
calculating electronically a monetary amount owed by the audiovisual delivery entity based on the information about the sales; and
communicating monetary amount data relating to the monetary amount owed to the audiovisual delivery entity.
